(19) United States
(12) Patent Application Publication
(10) Pub. No.: US 2026/0283077 A1
(43) Pub. Date: Sep. 24, 2026

(54) A DEVICE FOR INJECTING A LIQUID INTO A BALE

(71) Applicant: J CARLSON PTY LTD, Sydney (AU)

(72) Inventor: Johnathan Cecil Carlson, Sydney (AU)

(73) Assignee: J CARLSON PTY LTD, Sydney (AU)

(21) Appl. No.: 19/475,437

(22) PCT Filed: Mar. 25, 2024
(86) PCT No.: PCT/AU2024/050273

§ 371 Date: Oct. 15, 2025

(30) Foreign Application Priority Data
Apr. 21, 2023 (AU) 2023901189

(51) Int. Cl. A01F 15/08; A01G 18/22

(52) U.S. Cl. CPC A01F 15/0816; A01G 18/22

(57) ABSTRACT

A device for injecting a liquid into a bale, wherein the device comprises: at least one injection spike for insertion into the bale and the spike having a fluid passage therethrough; a frame for supporting the bale; a retractable bar for rigidly securing the spike on; a fluid feed pump for injecting a fluid into the bale from a fluid source through the fluid passage of the spike; where the spike comprises a terminal aperture at a bale contact end; and further comprises a side aperture toward the bale contact end; wherein when in use, a hydraulic ram mounted above the bar, which the ram is adapted to actuate and apply downward compressive pressure on the bar and spike when in use; where the spike is rigidly secured on the bar and are adapted to inject liquid into the bale before the hydraulic ram retracts.

### TECHNICAL FIELD

The present invention relates to a device for injecting a liquid into a bale. More specifically, the invention pertains to the agricultural field and may be a device for injecting recycled water containing organisms into organic substrates and substances.

### BACKGROUND

It is common within the agricultural industry to spray cereal straw bales with liquids and nutrients for the purpose of providing composting materials for use in agriculture or for providing nutrient rich forage feed stuffs for animals. Spraying cereal straw bales is a process used in agriculture to prepare the straw for use as a growing medium for mushrooms or as animal bedding. The process involves soaking the straw bales with water to create a moist environment that is conducive to microbial growth.

The importance of spraying cereal straw bales lies in the fact that it helps to transform a low-value agricultural by-product into a high-value commodity. Cereal straw is typically seen as a waste product after the grain has been harvested. However, by treating it with water and adding mushroom spores or using it as animal bedding, the straw can be turned into a valuable product.

For mushroom cultivation, cereal straw bales serve as an alternative substrate to traditional materials like sawdust or compost. This method can be particularly useful in areas where other growing media are scarce or expensive. Additionally, the cultivation of mushrooms on cereal straw bales can provide farmers with a new revenue stream and increase the efficiency of their operations.

For animal bedding, spraying cereal straw bales can help to reduce the spread of diseases and parasites. By soaking the straw, any harmful bacteria or fungi are killed off, which can lead to healthier livestock and a lower risk of disease transmission.

Spraying cereal straw bales with water and adding mushroom spores or spawn to them is a common method of growing mushrooms. The process involves thoroughly soaking the straw bales with water to create a moist, humid environment that is conducive to mushroom growth.

After the straw bales are soaked, mushroom spawn or spores are added to the straw. The mycelium in the spawn or spores then colonizes the straw, breaking it down and transforming it into a substrate that can support mushroom growth.

Spraying cereal straw bales is an important step in the mushroom growing process because it ensures that the substrate is moist and provides an ideal environment for the mycelium to colonize and grow. The moisture content of the substrate is critical to the success of mushroom cultivation, as mushrooms require a high level of humidity to grow.

Additionally, spraying the straw bales can help prevent the growth of unwanted fungi or bacteria that could compete with the mushroom mycelium for nutrients and space. It is also important to maintain a sterile environment during the process to prevent contamination, which could ruin the entire crop. Spraying cereal straw bales is a crucial step in mushroom cultivation as it provides the necessary moisture and helps create a sterile environment for the mycelium to grow, leading to a successful mushroom crop.

Although the spraying of bales is widely known, it has some shortcomings which the invention described herein will endeavour to alleviate. Some of the most common issues include:

Contamination: Spraying cereal straw bales with water creates a moist environment that is ideal for microbial growth. While this can be beneficial for mushroom cultivation or animal bedding, it also increases the risk of contamination. If the water used to soak the straw bales is not clean, it can introduce harmful bacteria or fungi that can negatively impact the crop or animals.

Pest Infestations: Spraying cereal straw bales can also attract pests such as insects or rodents that are attracted to the moist environment. These pests can damage the crop or bedding, or spread disease to animals.

Waterlogging: Excessive moisture can cause cereal straw bales to become waterlogged, which can inhibit microbial growth and impact the overall quality of the crop or bedding.

Inconsistent Moisture: Inconsistent moisture levels in the cereal straw bales can lead to uneven microbial growth, resulting in a lower yield of mushrooms or poor quality bedding for animals.

Environmental Impact: Depending on the size and scale of the operation, spraying cereal straw bales with water can also have environmental impacts such as water usage, runoff, and waste management.

A method of overcoming these shortcomings is known, and it involves the injection of liquid into bales. This significantly reduces the environmental impact, by concentrating the treatment area, as well as being able to use high density bales, in turn saving transport costs.

In recent years, bale injection devices have been proposed to overcome these issues. U.S. Pat. No. 4,606,172 issued August 1986 to Miller discloses a plurality of spikes for driving into the bale to deliver ammonia therethrough. The device is adapted to be operated on the frame of a tractor, reducing its viability as an industrial, high-throughput process.

U.S. Pat. No. 4,185,549 issued 1980 to Roepnack discloses a reciprocating plunger for compacting fibrous materials, where there is included two spikes for delivering liquid under pressure when the plunger is depressed. A serious shortcoming of this invention is the capability of the device to inject into a high density of bale, and requires the bale to be non-compacted for insertion, where when the plunger is depressed resulting in compacting, the device is able to insert into the pre-compacted material.

There is a well-known problem in the prior art being the absence of a device that is capable of impacting and injecting a high-density bale without breaking off the spikes, and without compromising on the compactness of the bale in order to achieve the goal of a bale injection device. Once attempt is disclosed in Canadian Patent No. 2,227,018 where a device is disclosed having a plurality of injections spikes attached to a support member by a resilient member. The resilient member is a coil and therefore if the spike were to meet a solid mid-section of the bale, its path could be altered via the resilient member without affecting the path of injection for the other spikes. This results in a fragile arrangement, where the coils (resilient member) become worn overtime, and also results in a non-consistent injection method where some areas of the bale may not be injected with any organic matter.

There still exists a need for a device for injection of a bale in which a prepared dense bail can be injected commercially in high-throughput which ameliorates the shortcomings of the cereal straw spraying method or discloses injection spike methods as discussed.

Any discussion of the prior art throughout the specification should in no way be considered as an admission that such prior art is widely known or forms part of common general knowledge in the field.

### SUMMARY

### Problems to be Solved

It may be an objective of the present invention to provide a device for injecting a liquid into a bale where the spikes are rigidly attached to a support member, and a hydraulic means is utilised to drive the spikes into a high density bale.

It may be an objective of the present invention to provide a device for injecting a liquid into a bale where the bale is high density (>470 kg).

It may be an objective of the present invention to provide a device for injecting a liquid into a bale where the spikes are adapted to be able to deliver a high volume of liquid in a short time without complications.

It may be an object of the present invention to provide a device for injecting a liquid into a bale where the spikes are able to withstand high force which may be present in a highly compacted bale.

It may be an objective of the present invention to provide a device for injecting a liquid into a bale where the waste and costs are reduced due to the concentration and targeted delivery of a liquid to a bale.

It is an object of the present invention to overcome or ameliorate at least one of the disadvantages of the prior art, or to provide a useful alternative.

### Means for Solving the Problem

In a first aspect of the present invention, there is provided a device for injecting a liquid into a bale, the device comprising at least one injection spike for insertion into the bale and the spike having a fluid passage therethrough, a frame for supporting the bale, a retractable bar for rigidly securing the spike on, a fluid feed pump for injecting a fluid into the bale from a fluid source through the fluid passage of the spike, where the spike comprises a terminal aperture at a bale contact end, and further comprises a side aperture toward the bale contact end, wherein when in use, a hydraulic ram mounted above the bar, which the ram is adapted to acuate and apply downward compressive pressure on the bar and spike when in use, where the spike is rigidly secured on the bar and are adapted to inject liquid into the bale before the hydraulic ram retracts.

Preferably, the spike is rigidly secured on the bar through welding such that it is not moveable.

Preferably, the spike is secured on the bar via a permanent securing means.

Preferably, the fluid feed pump delivers the liquid at a volume of 800 to 1700 litres per minute (LPM).

Preferably, the fluid feed pump delivers the liquid at a volume of 1160 litres per minute (LPM).

Preferably, the injected bale is high-density and weighs 500 to 1500 kilograms.

Preferably, the frame for supporting the bale further comprises a bale shelf.

Preferably, the frame for supporting the bale further comprises a plurality of mounting feet.

Preferably, the device further comprises a controller operatively connected to the hydraulic ram.

Preferably, the frame for supporting the bale is galvanised.

Preferably, the spike is coated in titanium alloy.

Preferably, the fluid feed pump is a high volume and density pump.

Preferably, the bale is cereal straw specifically for mushroom growing.

Preferably, the bale is organic material specifically adapted and chosen for mushroom growing.

Preferably, the liquid contains water, mesophilic organisms, thermophilic organisms and nitrogen rich organic substances for growing mushrooms.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present invention aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a perspective view of the device for injecting a liquid into a bale in accordance with an embodiment of the present invention.

FIG. 2 depicts a front view of the device for injecting a liquid into a bale as depicted in FIG. 1.

FIG. 3A depicts an injection spike of the device for injecting a liquid into a bale in accordance with an embodiment of the invention.

FIG. 3B depicts a close-up view of FIG. 3A. in accordance with an embodiment of the invention.

### DESCRIPTION OF THE INVENTION

Preferred embodiments of the invention will now be described with reference to the accompanying drawings and non-limiting examples.

Although the invention has been described with reference to specific examples, it will be appreciated by those skilled in the art that the invention may be embodied in many other forms, in keep with the broad principles and the spirit of invention described herein.

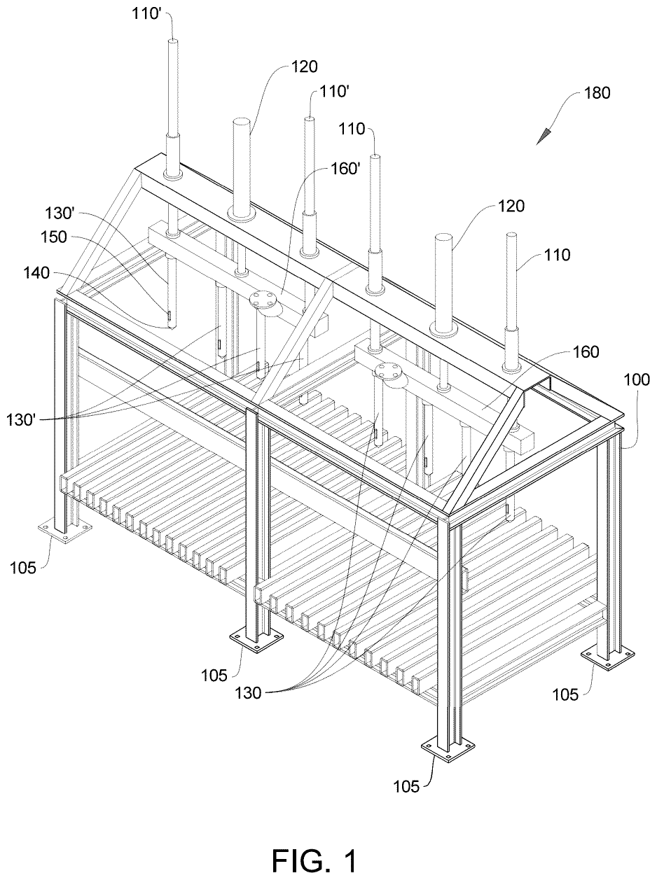

A first preferred embodiment of the present invention is depicted in FIG. 1. Referring to FIG. 1, there is provided a device for injecting a liquid into a bale 180 having a frame for supporting the bale 100 and mounting feet 105 for mounting the device to a warehouse or work area floor. Mounted above the bale, on the frame for supporting the bale 100 there is a retractable bar 160. The retractable bar 160 comprises a plurality of injection spikes 130, the injection spikes 130 further comprising a terminal aperture 140 and side aperture 150 for delivery of liquid therethrough the injection spike 130 to the bale when in use. The retractable bar 160 is driven down into the bale resulting in penetration of the bale by the injections spikes 130 by a series of guide rods 110 in conjunction with the actuation and subsequent de-actuation of hydraulic ram 120.

The device described in the first preferred embodiment is designed to inject liquid into a bale of material, such as hay or straw. The device includes a frame that is used to support the bale and has mounting feet for securing the device to a warehouse or work area floor.

Mounted above the bale is a retractable bar that is used to inject the liquid into the bale. The retractable bar consists of a series of injection spikes, each of which has a terminal aperture and a side aperture for delivering the liquid into the bale.

To use the device, the retractable bar is driven down into the bale using a series of guide rods in conjunction with the actuation and subsequent de-actuation of a hydraulic ram. As the bar is lowered, the injection spikes penetrate the bale, allowing the liquid to be delivered through the terminal and side apertures and into the bale.

Once the liquid has been injected, the retractable bar is raised back up to its starting position and the bale can be removed from the device. This process can be repeated for multiple bales, allowing for efficient and accurate liquid injection.

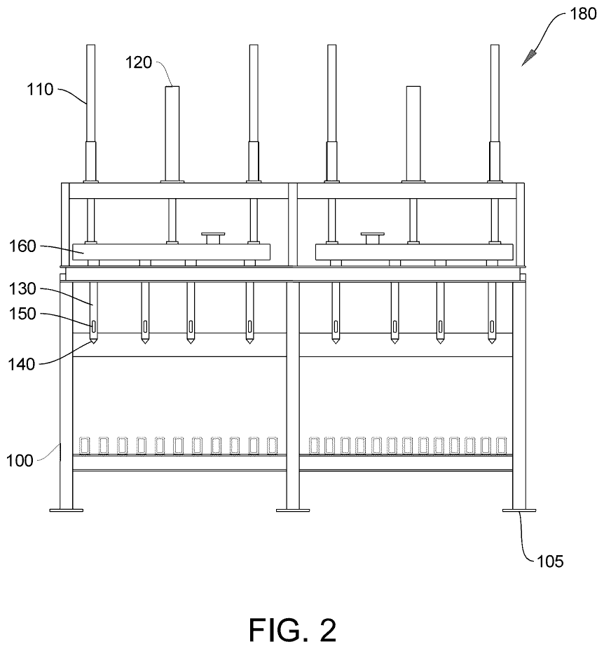

A second view of the present invention depicted in FIG. 1 is further represented in FIG. 2. Referring now to FIG. 2, there is provided a device for injecting a liquid into a bale 180 having a frame for supporting the bale 100 and mounting feet 105 for mounting the device to a warehouse or work area floor. Mounted above the bale, on the frame for supporting the bale 100 there is a retractable bar 160. The retractable bar 160 comprises a plurality of injection spikes 130, the injection spikes 130 further comprising a terminal aperture 140 and side aperture 150 for delivery of liquid therethrough the injection spike 130 to the bale when in use. The retractable bar 160 is driven down into the bale resulting in penetration of the bale by the injections spikes 130 by a series of guide rods 110 in conjunction with the actuation and subsequent de-actuation of hydraulic ram 120.

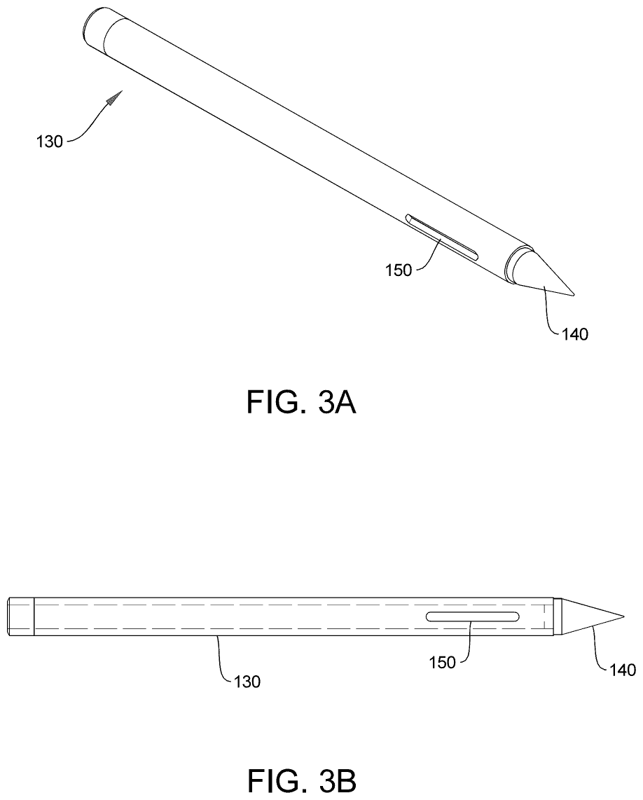

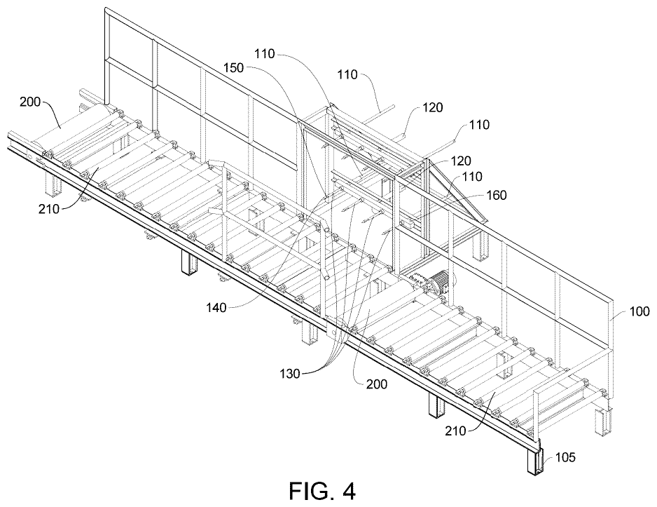

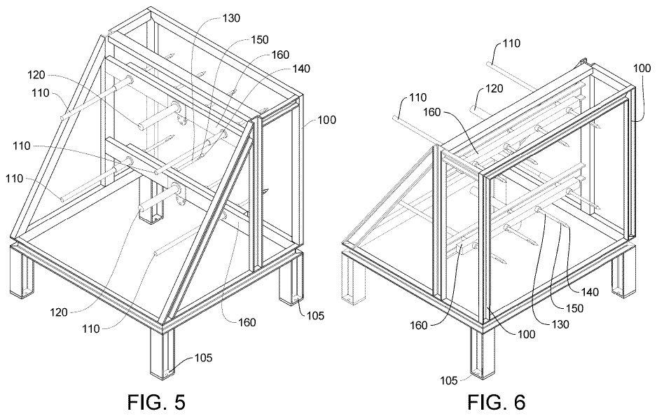

A close-up view of the injection spike 130 is depicted in FIG. 3A and FIG. 3B. Referring to FIG. 3A and FIG. 3B there is provided an injection spike 130 comprising a high-flow side aperture 150 for delivery of a liquid therethrough into the bale. In some embodiments, there may be a terminal aperture 140 present at the bale contact end of the injection spike 130.

A further embodiment of the present invention depicted in FIG. 4. Referring now to FIG. 4, there is provided a device for injecting a liquid into a bale having a frame for supporting the bale 100 and mounting feet 105 for mounting the device to a warehouse or work area floor. Mounted above the bale, on the frame for supporting the bale 100 there is a retractable bar 160. The retractable bar 160 comprises a plurality of injection spikes 130, the injection spikes 130 further comprising a terminal aperture 140 and side aperture 150 for delivery of liquid therethrough the injection spike 130 to the bale when in use. The retractable bar 160 is driven down into the bale resulting in penetration of the bale by the injections spikes 130 by a series of guide rods 110 in conjunction with the actuation and subsequent de-actuation of hydraulic ram 120. The embodiment may comprise rollers 200 wherein a bale is loaded at a first end and conveyed through the device by additional rollers 210 to allow high throughput bale injection, wherein the bale is removed at a second end of the device. Referring to FIG. 4, the bale may be loaded at the left hand side of the device 200, and conveyed through to the right hand side, being injected with the actuation device as it proceeds.

The actuation device as embodied in FIG. 4 may be of a horizontal form as depicted in FIG. 5 and FIG. 6. Referring to FIG. 5 and FIG. 6 there is provided a horizontal embodiment for use with the conveyor device in FIG. 4, wherein the features correspond at the respective reference numbers to that as depicted in FIG. 1.

In some embodiments, the bale may be a bale of wheat straw or cereal straw or organic matter or silage. The process of obtaining a wheat straw bale or cereal straw bale in an embodiment may include:

Harvesting: The wheat or other cereal crop is grown and harvested when it reaches maturity. During the harvesting process, the crop is cut and separated from the straw or stalk.

Baling: The straw is then baled using a baler, which compresses the straw into a tight, rectangular shape. The bales are typically tied with twine or wire to keep them together.

Storage: The bales are then stored in a dry and secure location, such as a barn or warehouse, until they are needed.

Treatment: If the bales are intended for use as animal bedding or mushroom cultivation, they may be treated with water or other chemicals to increase their moisture content and promote microbial growth.

Injection: In the case of mushroom cultivation, the bales may be injected with liquid spores to promote the growth of mushrooms according to an embodiment of this invention, and perhaps in accordance with the first embodiment of this invention.

In recent times, the bales were able to be sprayed via overhead sprinkler systems where they could absorb the liquid via capillary action due to the low density. In these embodiments, the bale type is able to be high-density due to the rigidly fixed injection spikes.

In an embodiment, the retractable bar action is hydraulically driven by a hydraulic ram joined or fixed to the upper surface of the bar. Hydraulics is a technology that uses fluid power to generate, control and transmit mechanical power. In the case of the embodiment with a retractable bar, hydraulics are used to actuate and de-actuate the bar.

The hydraulic system consists of a hydraulic ram, which is a piston that moves back and forth inside a cylinder. When the hydraulic system is activated, hydraulic fluid is pumped into one end of the cylinder, which pushes the piston and the attached retractable bar down towards the bale. Preferably, the hydraulic ram is positioned in the middle of the upper surface of the bar so as to apply downward compressive force through the bar.

Guide bars are used to ensure that the retractable bar moves straight down into the bale without bending or buckling. The guide bars provide a rigid support structure that keeps the retractable bar aligned and prevents it from deviating from its intended path.

As the retractable bar moves downward, the injection spikes on the bar penetrate the bale, allowing the liquid to be injected through the terminal and side apertures. Once the bar has reached the desired depth, the hydraulic system is deactivated and the hydraulic fluid is released from the cylinder, allowing the retractable bar to be raised back up to its starting position.

In an embodiment, the hydraulic movement of the retractable bar is computerised. A hydraulically operated retractable bar can be computerized by adding electronic control and monitoring systems to the hydraulic and mechanical components. This can be done by integrating electronic sensors and controllers into the hydraulic system, which can be programmed to automatically control the actuation and de-actuation of the retractable bar.

For example, a computerized system can be programmed to control the speed and force of the hydraulic ram, ensuring that the retractable bar moves at a consistent and controlled rate. The system can also be programmed to monitor the pressure and flow of the hydraulic fluid, allowing for precise control of the injection process.

In addition to the hydraulic system, a computerized system can also include sensors and controllers for the guide bars and injection spikes. These sensors can detect any deviations in the alignment or positioning of the retractable bar, and the controllers can adjust the hydraulic system accordingly to ensure that the injection process is precise and accurate. Computerizing a hydraulically operated retractable bar can increase efficiency and accuracy in the injection process, reduce the potential for errors or deviations, and allow for real-time monitoring and adjustment of the system.

In a further embodiment of the present invention, device could have two bays, each equipped with a frame for supporting a bale, retractable bar with injection spikes, hydraulic ram, and guide rods. The two bays would be located side-by-side to allow for simultaneous loading and injection of bales. To use the device, an operator would first load a bale into the first bay and secure it in place using the frame. Once the bale is loaded, the operator would press a button or activate a switch to start the injection process. This would activate the hydraulic system, which would drive the retractable bar down into the bale, injecting the liquid through the injection spikes.

While the injection process is underway in the first bay, the operator can load a second bale into the second bay. Once the first injection process is complete, the operator can remove the injected bale from the first bay and replace it with a new bale. The operator can then press the button or switch to start the injection process in the second bay, while loading a new bale into the first bay. This process can be repeated as necessary to inject multiple bales. The use of two bays allows for continuous injection of bales, reducing downtime and increasing efficiency. The electronic control and monitoring systems can also be programmed to keep track of the injection process in each bay and adjust the injection parameters as necessary to ensure accurate and consistent results.

In an embodiment of the invention, high-density bales may be used, providing an advantage of the present invention over the prior art. When it comes to transport and storage, using high-density bales is advantageous over low-density ones because they occupy less space and require less handling. High-density bales can be compressed more tightly, resulting in a smaller volume of material for a given weight. This means that more material can be transported and stored in a given space, reducing transportation costs and storage requirements.

High-density bales are also more durable and can withstand the weight of other bales stacked on top of them without deforming or collapsing. This reduces the risk of damage to the bales during transportation and storage.

From a use case perspective, high-density bales also offer advantages over low-density ones. Because they are more compact, they require less storage space, which can be beneficial in situations where storage space is limited. High-density bales are also easier to handle and transport on-site, reducing labor and equipment costs.

In addition, high-density bales can provide more consistent material quality and uniformity. Because the material is compressed more tightly, there is less air space between the material, resulting in less variation in density and moisture content. This can be important in applications such as mushroom growing, where consistent material quality is critical to the success of the process.

In an embodiment, the injection spike passage may be connected to a high-volume, high-pressure pump. Using a high volume, high-pressure pump in the device for injecting liquid into a bale offers several advantages:

Faster injection: A high-volume pump can inject more liquid into the bale in a shorter amount of time. This can reduce the overall injection time per bale and increase the number of bales that can be processed in a given amount of time.

Consistency: A high-pressure pump can deliver a consistent flow of liquid to the injection spikes, ensuring that each bale receives the same amount of liquid per unit of time. This can result in more consistent quality and yields in the end product.

Efficiency: A high-volume pump can reduce the number of injection spikes needed, which can reduce the overall cost of the device and make it more efficient.

Flexibility: A high-pressure pump can be adjusted to deliver different amounts of liquid depending on the needs of the user. This can make the device more versatile and adaptable to different applications.

Increased pressure: A high-pressure pump can inject the liquid deeper into the bale, which can result in better distribution of the liquid throughout the bale. This can be important in applications where uniformity of liquid distribution is critical.

In an embodiment, the injection spikes may include a large side aperture as well as a terminal aperture. This is advantageous over the prior art as it allows for:

Faster injection: A larger side aperture and terminal aperture can allow the liquid to flow more quickly through the injection spikes and into the bale. This can result in faster injection times and more efficient use of the device.

Uniform distribution: A larger side aperture and terminal aperture can help to ensure more uniform distribution of the liquid throughout the bale. This can be particularly important when injecting liquid into a large bale or when using a fast injection rate.

Reduced clogging: A larger aperture can also help to reduce the risk of the injection spikes becoming clogged with straw or other material. This can reduce the need for maintenance and cleaning of the device, which can save time and money.

Increased capacity: A larger side aperture and terminal aperture can allow the device to handle a higher volume of liquid, which can be important in applications where large volumes of liquid need to be injected into the bale quickly.

In a further embodiment, the injection spikes may be made of a durable material, which are then plated in further material to reduce microbial loss due to contamination. The injection spikes in the device could be made of various materials, such as stainless steel, aluminium, or other durable metals, to increase strength and durability. In addition, plating or coating the injection spikes with materials that are resistant to corrosion and microbial growth could help reduce the loss of microorganisms during the injection process. Some materials that could be used for plating or coating the injection spikes include:

Chromium: Chromium plating can help improve the hardness and corrosion resistance of the injection spikes.

Titanium: Titanium coatings can offer excellent corrosion resistance, biocompatibility, and durability, making it a popular choice in biotechnological applications.

Ceramic: Ceramic coatings can provide a high level of hardness and wear resistance, which can be important in applications where the injection spikes are subjected to significant wear and tear.

PTFE: PTFE (polytetrafluoroethylene) coatings can provide excellent resistance to chemicals, moisture, and microbial growth, making it a good choice for applications where hygiene and cleanliness are critical.

Selecting durable and corrosion-resistant materials for the injection spikes and using appropriate plating or coating materials can help increase the strength and durability of the device and reduce the loss of microorganisms during the injection process.

In a further embodiment of the present invention, the injection spikes are secured to the retractable bar through a hex nipple that is welded into the retractable bar. The hex nipple is BSP (British Standard Pipe) threaded, which allows the spikes to be screwed into the retractable bar. This design allows for the injection spikes to be considered consumables, meaning they can be replaced as needed, resulting in more cost-effective maintenance of the device.

The use of BSP threaded hex nipples allows for the injection spikes to be easily removed and replaced without the need for specialized tools or equipment, which can save time and money in maintenance and repair of the device. Additionally, the BSP threading provides a secure and reliable connection between the injection spikes and the retractable bar, ensuring that the spikes remain firmly and rigidly attached during the injection process.

The welding of the hex nipple into the retractable bar provides additional strength and durability to the connection, further ensuring the reliability and safety of the device during operation. By using this embodiment, the injection spikes can be replaced as necessary, reducing the need for costly repairs or replacement of the entire retractable bar assembly, resulting in increased efficiency and cost savings in maintaining the device.

In a further embodiment of the present invention, the injection spikes are secured to the retractable bar via a hex nipple that is welded into the retractable bar. The hex nipple is NPT (National Pipe Thread) threaded, allowing the injection spikes to be easily screwed into and out of the retractable bar. This feature makes the spikes consumable and easily replaceable when they become worn or damaged.

NPT threading is a standardized threading used in North America for joining pipes and fittings. This threading allows for a tight and secure connection between the injection spikes and the retractable bar, ensuring that the spikes remain firmly in place during the injection process.

The use of replaceable injection spikes provides several benefits to the device. Firstly, it allows for easy maintenance and repair of the device, reducing downtime and associated costs. Secondly, it allows for the use of different types of injection spikes, depending on the type of liquid being injected or the specific requirements of the user.

Furthermore, the use of NPT threading in this embodiment provides a standardized and easily replaceable connection, simplifying the replacement process for the injection spikes. This results in a more efficient and user-friendly device, reducing the time and effort required to maintain and repair the device.

In a further embodiment of the present invention, the injection spikes are secured to the retractable bar via a hex nipple that is tapered. When the injection spikes are screwed into the tapered hex nipple, they are pulled up tight, resulting in a secure and snug fit.

The tapering of the hex nipple means that the diameter of the thread increases gradually towards the end of the hex nipple. This means that as the injection spikes are screwed into the hex nipple, they are forced to follow the taper and become increasingly tight as they are screwed in further. This results in a secure and snug fit between the injection spikes and the hex nipple.

The advantage of this design is that it ensures that the injection spikes are firmly secured to the retractable bar, reducing the likelihood of any movement or slippage during the injection process. This can be particularly important when injecting liquids at high pressures and speeds, as any movement or slippage could result in the injection not being effective.

In a further embodiment of the present invention, the frame for supporting the bale is made of heavy-duty steel, which has high tensile strength and is capable of withstanding the weight of the bale during the injection process. The steel frame is welded together, which helps to create a strong and rigid structure that can withstand the stresses of the injection process.

However, since the liquid medium used in the injection process is often corrosive, there is a risk of corrosion damage to the steel frame over time, which could compromise the safety and performance of the device. To address this, the steel frame is hot-dipped in galvanizing, which involves immersing the steel in a bath of molten zinc. The zinc coating forms a protective barrier on the surface of the steel, which can help to prevent corrosion and increase the longevity of the device. This approach is a well-established and widely used technique for protecting steel structures against corrosion in harsh environments. In the context of the present invention, the use of heavy-duty steel, followed by hot-dip galvanizing, provides a robust and effective solution to prevent corrosion and ensure the safe and reliable operation of the device over an extended period of time.

In a further embodiment of the present invention, both the injection spikes and the injection piping are made of schedule 160, 316 grade stainless steel. The use of high-quality stainless steel materials provides a high level of corrosion resistance, ensuring that the device remains in good condition for longer periods of time, even when exposed to the corrosive nature of the liquid medium used for injection.

Stainless steel is an alloy that contains a minimum of 10.5% chromium, which gives it its unique corrosion-resistant properties. This material is commonly used in applications where resistance to corrosion is required, making it an ideal choice for use in the present invention.

The use of schedule 160 stainless steel for the injection spikes and piping provides additional strength and durability to the device, allowing it to withstand the high pressures and forces generated during the injection process. This ensures that the device remains in good working order for extended periods of time, reducing the need for maintenance and repairs.

It will be appreciated by those skilled in the art that the hydraulic ram mounted above the bar, which the ram is adapted to actuate and apply downward compressive pressure on the bar and spike when in use can be applied such that the bar is mounted in a way where the bar always pushes downward with respect to the hydraulic ram.

That is, a person skilled in the art would recognise that even if the spikes are inserted from the bottom, rear or side of the bales, that downward compressive pressure is still nonetheless applied as this is in respect to the hydraulic ram.

The claims defining the invention are as follows:

1. A device for injecting a liquid into a bale, wherein the device comprises:
at least one injection spike for insertion into the bale and the spike having a fluid passage therethrough;
a frame for supporting the bale;
a retractable bar for rigidly securing the spike on;
a fluid feed pump for injecting a fluid into the bale from a fluid source through the fluid passage of the spike;
where the spike comprises a terminal aperture at a bale contact end;
and further comprises a side aperture toward the bale contact end;
wherein when in use, a hydraulic ram mounted above the bar, which the ram is adapted to actuate and apply downward compressive pressure on the bar and spike when in use;
where the spike is rigidly secured on the bar and are adapted to inject liquid into the bale before the hydraulic ram retracts.

2. The device of claim 1, wherein the frame for supporting the bale includes a conveyance means for delivering the bale to the device.

3. The device of claim 1, wherein the spike is rigidly secured on the bar through welding such that is its not moveable.

4. The device of claim 1, wherein the spike is secured on the bar via a permanent securing means.

5. The device of claim 1, wherein the fluid feed pump delivers the liquid at a volume of 800 to 1700 litres per minute (LPM).

6. The device of claim 1, wherein the fluid feed pump delivers the liquid at a volume of 1160 litres per minute (LPM).

7. The device of claim 1, where the injected bale is high-density and weighs 500 to 1500 kilograms.

8. The device of claim 1, where the frame for supporting the bale further comprises a bale shelf.

9. The device of claim 1, where the frame for supporting the bale further comprises a plurality of mounting feet.

10. The device of claim 1, where the device further comprises a controller operatively connected to the hydraulic ram.

11. The device of claim 1, where the frame for supporting the bale is galvanised.

12. The device of claim 1, where the spike is coated in titanium alloy.

13. The device of claim 1, where the fluid feed pump is a high volume and density pump.

14. The device of claim 1, where the bale is cereal straw specifically for mushroom growing.

15. The device of claim 1, where the bale is organic material specifically adapted and chosen for mushroom growing.

16. The device of claim 1, where the liquid contains water, mesophilic organisms, thermophilic organisms and nitrogen rich organic substances for growing mushrooms.
